(19) United States
(12) Patent Application Publication
(10) Pub. No.: US 2025/0389542 A1
(43) Pub. Date: Dec. 25, 2025

(54) ARTIFICIAL INTELLIGENCE ROUTE GENERATION AND CROSS-PLATFORM MOBILE APPLICATION FOR A GIG ECOSYSTEM

(71) Applicant: State Farm Mutual Automobile Insurance Company, Bloomington, IL (US)

(72) Inventor: Greg R. Louck, Bloomington, IL (US)

(21) Appl. No.: 19/212,022

(22) Filed: May 19, 2025

Related U.S. Application Data
(60) Provisional application No. 63/662,229, filed on Jun. 20, 2024.

(51) Int. Cl. G01C 21/34; G01C 21/36

(52) U.S. Cl. CPC G01C 21/3446; G01C 21/3453; G01C 21/3617

(57) ABSTRACT

A computer system may be provided. The computer system may include at least one processor. The at least one processor may be programmed to: (a) cause, using an application executing on the user device, the user device to display a plurality of trip assignments, each of the plurality of trip assignments associated with a trip assignment provider device of a plurality of trip assignment provider devices; (b) receive, from the user device, a selection of one or more of the plurality of trip assignments, each of the one or more selected trip assignments including trip information including at least an origin and a destination; (c) generate an optimal route based upon the trip information using an AI model, wherein the AI model is trained using historical trip records including historical trip information associated with historical trips; and (d) cause, using the application, the user device to display the generated route.

### CROSS-REFERENCE TO RELATED APPLICATIONS

This application claims the benefit of priority to U.S. Provisional Application Ser. No. 63/662,229, filed Jun. 20, 2024, the contents and disclosures of which are hereby incorporated herein by reference in their entirety.

### FIELD OF USE

The present disclosure relates to generating transportation routes for users of multiple gig platforms and, more particularly, to a computer system and method configured to use artificial intelligence (AI) tools to generate enhanced transportation routes for drivers that use multiple gig platforms within a gig ecosystem, and manage the data generated from the driver using the multiple gig platforms.

### BACKGROUND

Individuals use mobile devices (e.g., mobile telephones) for a variety of purposes and often carry mobile devices while traveling. Such usage and the carrying of the devices may be a source of data. For example, mobile devices may be equipped to generate data (e.g., telematics data and/or location data) using instruments built into the mobile device, such as an accelerometer or global positioning system (GPS) device. This data obtained from mobile devices may be useful for a variety of applications.

For example, freelance or “gig economy” drivers may utilize mobile applications to receive information about and to accept trip assignments such as deliveries or rideshare trips. The information provided may include a route or directions for reaching an associated origin and destination. These mobile applications may also track these drivers to determine, for example, whether a trip assignment has been completed and an appropriate compensation for a driver. Generally, each rideshare or delivery platform has its own corresponding mobile application. Accordingly, a driver desiring to work for multiple platforms simultaneously must use multiple mobile applications at the same time. Additionally, when a driver is performing trip assignments originating from different platforms that overlap in time, these mobile applications are unable to generate a route that would satisfy the different trip assignments.

Conventional techniques may include inefficiencies, ineffectiveness, encumbrances, and/or other drawbacks as well.

### BRIEF SUMMARY

The present embodiments may relate to, inter alia, systems and methods for automated optimal route generation for a driver using an AI model, wherein an optimal route may be generated for a driver operating in a gig economy that uses multiple gig platforms to deliver multiple items (e.g., persons and packages) within a combined or overlapping delivery route. In exemplary embodiments, the systems and methods may be performed by a server computing device, a bank of server computing devices, and/or other computing devices, which may be in communication with one or more user devices, which may each be associated with respective drivers and configured to execute a mobile application. The server computing device may be in further communication with a plurality of entities referred to herein as “trip assignment providers,” which may include ridesharing or transportation network companies (TNCs), food delivery services, and/or last-mile delivery services, which may provide assignments (sometimes referred to herein as “trip assignments”) to transport people or items. The server computing device may receive a selection of one or more trip assignments from the driver via the application executing on the user device and may generate an optimal route for the driver using an AI model based upon the selected one or more routes and other data relating to the driver, and present the combined route to the driver via the application.

In one aspect, a computer system for generating a transportation route using machine learning and/or artificial intelligence tools may be provided. The system may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, a computer system comprising at least one memory and at least one processor in communication with the at least one memory is provided. The at least one processor may be programmed to: (a) cause, using an application executing on the user device, the user device to display a plurality of trip assignments, each of the plurality of trip assignments associated with a trip assignment provider device of a plurality of trip assignment provider devices; (b) receive, from the user device, a selection of one or more of the plurality of trip assignments, each of the one or more selected trip assignments including trip information, the trip information including at least an origin and a destination; (c) generate a route based upon the trip information using an AI model, wherein the AI model is trained using historical trip records including historical trip information associated with historical trips; and (d) cause, using the application, the user device to display the generated route. The computer system may perform additional, less, or alternate functionality, including that discussed elsewhere herein.

In another aspect, a computing device for generating a transportation route using machine learning and/or artificial intelligence tools may be provided. The computing device may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, a computing device may comprise at least one memory and at least one processor in communication with the at least one memory. The at least one processor may be programmed to: (a) cause, using an application executing on the user device, the user device to display a plurality of trip assignments, each of the plurality of trip assignments associated with a trip assignment provider device of a plurality of trip assignment provider devices; (b) receive, from the user device, a selection of one or more of the plurality of trip assignments, each of the one or more selected trip assignments including trip information, the trip information including at least an origin and a destination; (c) generate a route based upon the trip information using an AI model, wherein the AI model is trained using historical trip records including historical trip information associated with historical trips; and (d) cause, using the application, the user device to display the generated route. The computing device may perform additional, less, or alternate functionality, including that discussed elsewhere herein.

In yet another aspect, a computer-implemented method for generating a transportation route using machine learning and/or AI tools may be provided. The computer-implemented method may be performed by one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. The computer-implemented method may include: (a) causing, using an application executing on the user device, the user device to display a plurality of trip assignments, each of the plurality of trip assignments associated with a trip assignment provider device of a plurality of trip assignment provider devices; (b) receiving, from the user device, a selection of one or more of the plurality of trip assignments, each of the one or more selected trip assignments including trip information, the trip information including at least an origin and a destination; (c) generating a route based upon the trip information using an AI model, wherein the AI model is trained using historical trip records including historical trip information associated with historical trips; and (d) causing, using the application, the user device to display the generated route. The computer-implemented method may include additional, less, or alternate functionality, including that discussed elsewhere herein.

In still another aspect, a non-transitory computer-readable media for generating a transportation route using machine learning and/or AI tools may be provided. The non-transitory computer-readable storage media may include computer-executable instructions that may be executed by one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, a computer system may include at least one memory and at least one processor in communication with the at least one memory. The computer-executable instructions may cause the at least one processor to: (a) cause, using an application executing on the user device, the user device to display a plurality of trip assignments, each of the plurality of trip assignments associated with a trip assignment provider device of a plurality of trip assignment provider devices; (b) receive, from the user device, a selection of one or more of the plurality of trip assignments, each of the one or more selected trip assignments including trip information, the trip information including at least an origin and a destination; (c) generate a route based upon the trip information using an AI model, wherein the AI model is trained using historical trip records including historical trip information associated with historical trips; and (d) cause, using the application, the user device to display the generated route. The computer-executable instructions may direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed herein. However, it should be understood that the present embodiments are not limited to the precise arrangements and/or instrumentalities shown herein.

FIG. 1 depicts an exemplary computer system in accordance with an exemplary embodiment of the present disclosure.

FIG. 2 depicts an exemplary client computing device that may be used with the computer system illustrated in FIG. 1.

FIG. 3 depicts an exemplary server system that may be used with the computer system illustrated in FIG. 1.

FIG. 4 depicts an exemplary connected vehicle that may be used with the computer system illustrated in FIG. 1.

FIG. 5A is a flowchart that illustrates an exemplary computer-implemented method for AI-based route generation.

FIG. 5B is a continuation of the flowchart showing the exemplary computer-implemented method shown in FIG. 5A.

FIG. 5C is a continuation of the flowchart showing the exemplary computer-implemented method shown in FIGS. 5A and 5B.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, systems and methods for automated optimal route generation using an AI model. More specifically, the present embodiments relate to generating transportation routes for drivers that use multiple gig platforms and, more particularly, to a computer system and method configured to use artificial intelligence (AI) tools to generate optimal transportation routes for drivers that use multiple gig platforms within a gig ecosystem, and manage the data generated from the driver using the multiple gig platforms.

In exemplary embodiments, the systems and methods may be performed by a server computing device, a bank of server computing devices, and/or other computing devices, which may be in communication with one or more user devices, which may each be associated with respective drivers and configured to execute a mobile application. The server computing device may be in further communication with a plurality of entities referred to herein as “trip assignment providers,” which may include ridesharing or transportation network companies (TNCs), food delivery services, last-mile delivery services, and/or any other transportations systems used within the gig ecosystem, which may provide assignments (sometimes referred to herein as “trip assignments”) to transport people or items.

The server computing device may receive a selection of one or more trip assignments from the driver via the application executing on the user device and may generate an optimal route for the driver using an AI model based upon the selected one or more routes and other data relating to the driver, and present the route to the driver via the application. The generated route may include a path that, for each trip assignment, connects the corresponding origin and destination. In some cases, the trip assignments may overlap in time. For example, for two trip assignments “A” and “B,” the generated route may first pass though an origin of trip assignment A and an origin of trip assignment B, and then pass through a destination of trip assignment A and end at a destination of trip assignment B. The server computing device may cause the application executing on the user device to display a user interface, through which the user may register with trip assignment providers, view and select trip assignments, and view routes generated using the AI model. The user interface may then display instructions associated with the generated route, such as turn-by-turn road directions and instructions for picking up or dropping of people or items. As explained below, the system may also be configured to recommend which trip assignments for the driver to select that are being offered by the same or different trip assignment providers so as to maximize the driver's delivery efficiency, maximize payment to the driver, minimize risk to the driver, and/or apply any other preference the driver may wish to input into the system.

The server computing device may generate the AI model, which may be used to generate the optimal routes based upon data input by the user (e.g., trip assignments selected via the application, and/or preferences of the driver) and other data that may be retrieved by the server computing devices (e.g., geographic data including a current location of the driver, contextual data such as traffic, weather, and/or road conditions, and user profile data indicating preferences of the diver). The AI model may be trained using historical trip records, which may include historical trips and data associated with the historical trips (e.g., historical destinations, routes, mileages, telematics data collected during the trip, driver earnings, costs such as fuel and/or insurance costs, user feedback, and/or events such as collisions and/or injuries occurring during the trip). The AI model may determine factors such as a distance, duration, cost, potential earnings for the driver (e.g., compared to alternative routes), and/or safety of various potential routes, which may be used to select the route.

In some embodiments, the server computing device may collect telematics data (e.g., acceleration, cornering, braking, position, velocity, orientation, speed, location, GPS location or other GPS information, etc.) during trips. Such telematics data may be generated by sensors of the user device, sensors of transportation devices or telematics devices communicatively linked to the user devices, and/or from other sources that may provide telematics data. This telematics data may be used to confirm that a driver has completed trip assignments, and may further be used, along with historical data relating to events (e.g., accidents) occurring during the trips, to train the AI model, for example, to generate future routes, generate recommendations of trip assignments and routes for a driver, and/or determine a safety and/or generate a risk or loss score (e.g., associated with a likelihood of an injury or financial loss occurring) associated with a driver or route, which may be used to determine an insurance cost for a trip and/or to generate routes that prioritize safety of the user.

### Retrieving Data for Generating Optimal Routes and Recommendations

In the exemplary embodiment, the server computing device may be configured to retrieve data that may be used to identify trip assignments to present to the user, and to generate a route for the user if the trip assignments are accepted. This data may include data relating to the user (referred to herein as “driver information”), data relating to specific trip assignments (referred to herein as “trip assignment information”), which may be provided by one or more trip assignment providers in communication with the server computing device, and other contextual data (e.g., a current location of the user, road, traffic, and weather data, etc.).

The driver information may include trip assignment providers with which the user has registered, preferences to use certain types of transportation, age, health information, demographic information, historical trips and trip patterns, historical usage of different types of transportation, frequently visited locations, historical accident information, historical events and/or claims, and/or preferred billing option. The driver information may be retrieved from a database, the Internet, and/or other sources capable of providing such data. For example, user profiles including driver information may be stored for each user in the database. The driver information may be entered by the user (e.g., via a preferences and/or settings interface of the mobile app), automatically compiled based upon historical trips, and/or automatically retrieved from other data sources (e.g., insurance, financial, and/or trip assignment provider accounts linked to the user profile and/or associated with the user). In some embodiments, the mobile app may initially autofill the user profile with automatically compiled driver information and allow the user to manually make changes to the information.

The driver information may further include historical telematics data (e.g., acceleration, cornering, braking, position, velocity, orientation, speed, location, GPS location or other GPS information, etc.) associated with previous trips taken by the user. The telematics data may be collected by sensors of the mobile device, sensors of vehicles and/or telematics devices communicatively linked to the mobile device during trips (e.g., via Bluetooth and/or another wired or wireless communication protocol), and/or trip assignment provider accounts (e.g., rideshare driver accounts) linked to the user profile that may collect and/or store telematics data during trips. The user profile may further include user feedback from previous trips. For example, the mobile app may prompt the user to rate a trip upon completion of the trip, and over time, the server computing device may identify aspects of a trip that are preferred by the user based upon the submitted ratings.

The server computer device may receive, from a plurality of trip assignment providers, trip assignment information. This trip assignment information may include information relating to specific trip assignments (e.g., rideshare and/or delivery requests) provided by the trip assignment providers in response to requests from customers of the trip assignment providers. For example, the trip assignment information may include an origin and destination for a requested trip, waypoints, a trip type (e.g., rideshare, food delivery, parcel delivery, etc.), and a time for the trip assignment (e.g., whether immediate or at a future time and/or a time at which completion of the trip assignment is due). The trip assignment information may be used by the server computing device to determine to which users to present the trip assignments (e.g., users that are in an appropriate geographic area and/or have registered with the trip assignment provider corresponding to the trip). The trip assignment information may further be utilized by the server computing device for generating routes. For example, a generated route should pass though the origin and then the destination of a trip assignment accepted by a user.

In some embodiments, the server computing device may further retrieve geographic data based upon which the route may be generated. The geographic data may include data describing topography, locations or thoroughfares such as highways, roads, bike paths, trails, and sidewalks, mass transit routes, safety statistics (e.g., rates of traffic collisions and/or crime), and zones in which certain transportation services such as rideshares, bikeshares, and/or electric scooters are available. The geographic data may be retrieved from a database, the Internet (e.g., from third-party mapping services, such as Google Maps), and/or other sources capable of providing such data, and may be periodically or continually updated to reflect a current state.

In some embodiments, the server computing device may further retrieve contextual data, or data describing current or real-time conditions, based upon which the route may be generated. The contextual data may include data describing traffic conditions, road conditions (e.g., construction), major events that may affect traffic flow (e.g., locations of conventions, concerts and/or sporting events), weather, time of day, time of year, or other conditions that may affect travel. The contextual data may be retrieved from a database, the Internet (e.g., from third-party mapping services, such as Google Maps), and/or other sources capable of providing such data, and may be periodically or continually updated (e.g., in real time) to reflect current conditions. As described in further detail below, the server computing device may be configured to update generated routes in real time (e.g., after travel has started) if contextual data indicates that conditions have changed from when the route was initially generated.

### Generating a User Interface for Presenting and Selecting Optimal Routes and Recommendations

In the exemplary embodiment, the server computing device may cause, using an application executing on a user device of a user, the user device to display a plurality of trip assignments. The plurality of trip assignments may each be associated with a respective trip assignment provider.

The server computing device may select trip assignments to present to a user based upon the trip assignment information associated with available trip assignments and driver information associated with the user. For example, server computing device may identify trip assignments originating from trip assignment providers with which the user has registered and meet other user preferences (e.g., input by the user and/or otherwise identified by the server computing device, wherein these preferences may be selected and changed by the driver or automatically selected by the system). Examples of such preferences may include a geographic zone, maximum distance from a current location of the user, trip assignment type (e.g., rideshare versus delivery), time by which the trip assignment must be completed, expected length of the trip, maximize profits for the driver, and/or other such factors. Additionally, some of this information may be displayed by the user device executing the application along with each displayed trip assignment to assist the user in selecting which trip assignments to accept.

The user may select one or more trip assignments to accept via the application, and the user device may transmit this selection to the server computing device. The accepted trip assignments do not need to originate from the same trip assignment provider and/or type of trip provider. For example, the user may select two trip assignments originating from different rideshare services and/or one trip assignment from a rideshare service and one trip assignment from a food delivery service concurrently. The server computing device may transmit an acceptance message to trip assignment providers that are associated with the selected trip assignments. As described in further detail below, the server computing device my generate a route for the user based upon the selected trip assignments. By combining an ability to accept multiple trip assignments, which may originate from different trip assignment providers, within a single application may simplify the process of using different trip assignment providers simultaneously and therefore may reduce distracted driving by users accepting multiple trip assignments (e.g., as compared to using multiple different apps and/or user devices).

In some embodiments, the application may include a chatbot functionality, through which the user may be presented and/or accept trip assignments, request a route, and/or request other information using text and/or natural language. Such text and/or natural language inputs may be analyzed using AI and/or chatbot programs (e.g., ChatGPT), which in some embodiments may generate text and/or natural language responses to be presented through the application.

In certain embodiments, the application may provide a portal through which the user may register with trip assignment providers. A described above, the user may create a login account. Through the application, the user may enter or upload information that may be used to apply to different trip assignment providers, such as proof of insurance and/or drivers license information. The application may present a list of available trip service providers to which the user may apply (e.g., those operating in a geographic area of the user and/or likely to accept the user based upon the provided information), and the user may select trip service providers to apply. The server computing device may transmit this application to the selected trip service providers, which may accept the user's application based upon the submitted information and/or other information (e.g., a background check). The trip assignment providers may then report this acceptance to the server computing device, which may then record that the user has been registered with the accepting trip assignment providers. In some embodiments, trip assignment providers may present, via push notifications or other message displayed by and/or within the application, information such as promotions, bonuses, or other perks to certain users who may qualify (e.g., those in a certain geographic area).

### Building an Artificial Intelligence Model

In the exemplary embodiment, the server computing device may be configured to generate an AI model, also referred to herein as a route generating model, that may used to generate routes based upon trip assignment information, driver information, and/or other contextual information. In some embodiments, the server computing device may generate and/or train the route generating model using a training dataset that includes one or more training variables and/or model parameters, such as historical geographic data, historical contextual data, historical trip assignment information, and/or historical driver information.

In other embodiments, the server computing device may generate the route generating model in a different format. For example, the route generating model may be a function for receiving data (e.g., an origin and destination associated with a trip assignment, geographic data, contextual data, and user profile data) and generating an output for determining a route.

The server computing device may be configured to generate the route generating model by analyzing historical trip records including historical trip assignment information (e.g., historical destinations, routes, types of transportation used, telematics data, costs, user feedback, and/or events such as collisions and/or injuries occurring during the trip) associated with historical trips. The server computing device may be configured to perform a statistical analysis of the historical trip records to generate the structure assessment model. For example, for an aspect of a historical trip (e.g., destinations, routes, types of transportation used, telematics data, costs, user feedback, and/or events such as collisions and/or injuries that occurred during the trip), the server computing device may identify historical trip records associated with the aspect and generate model parameters (e.g., by identifying other parameters held in common among the identified historical trip records). For example, the server computing device may identify features correlated with a particular historical pattern. In other embodiments, the server computing device may be configured to perform a different analysis that is suitable to generate the route generating model.

The route generating model may be associated with and/or include a parametric engine. The parametric engine represents a relationship between input data such as training variables and/or predicted outputs. The training variables may be parameterized allowing the parametric engine to be tuned to generate accurate outputs. Parameterized training variables may be weighted using weighting coefficients. The parametric engine may be tuned to determine a magnitude and/or a direction of the weighting coefficients. Tuning may include iteratively using the parametric engine to generate model outputs that correspond to an actual event, such as a historical trip, while adjusting the magnitude and direction of the weight coefficients until the error between the model output and the actual event is reduced to an acceptable level. Tuning may be performed in addition to, and/or in combination with, training the model using historical data.

The parametric engine may use the weighted coefficients to rank an importance or influence of a model training variable. For example, if the weighting factor is greater, the greater the importance the server computing device will associate with that variable when tuning the model. Likewise, the smaller the weighting factor, the lesser the importance that the server computing device will associate with the variable when tuning the model. In some embodiments, the server computing device may weight variables associated with the historical trip records greater than any other model training variables.

In some embodiments, the server computing device may use a reduced number of training variables (e.g., one or more training variables) that have the greatest weighting factors (e.g., the variables that are ranked with the most importance). The reduced and more focused training dataset, including the training variables with the greatest weights, decreases computational load and will have decreased model training time allowing the model to be more quickly updated as more historical image records are created and added to the subset training dataset. The server computing device may generate a training dataset including less than a particular number (e.g., five or three) model training variables, for example.

### Generating an Optimal Route

In the exemplary embodiment, the server computing device may be further configured to generate routes based upon selected trip assignments and their corresponding trip assignment information using the trained AI model. The generated route may include a path that, for each trip assignment, connects the corresponding origin and destination. In some cases, the trip assignments may overlap in time. For example, for two trip assignments “A” and “B,” the generate route may first pass though an origin of trip assignment A and an origin of trip assignment B, and then pass trough a destination of trip assignment A and end at a destination of trip assignment B. As described in further detail below, the AI model may apply certain rules to determine when trip assignments can or cannot overlap. The generated route may be selected to achieve a greater or maximized expected earnings for the user, reduced or minimized time (e.g., overall time and/or time to complete each trip assignment), reduced or minimal distance or milage, reduced or minimal fuel consumption, and/or achieve some balance between these and/or other factors. In some embodiments, the server computing device may update and/or make changes to the route in real time (e.g., after the trip has started) based upon new data (e.g., data indicating traffic conditions have changed and/or service outages have occurred at a given location).

In some embodiments, the route may be generated by the AI model based upon driver information and other contextual data. This information may include, for example, predicted supply and demand for different types of trip assignments (e.g., whether there are few or many other drivers and/or people seeking transportation or deliveries in the area), user preferences as determined by trends over time, predicted trip durations associated with different potential routes, predicted trip lengths associated with different potential routes, predicted trip costs (e.g., insurance costs) associated with different potential routes, types of trip assignments (e.g., rideshare versus deliveries), numbers of stops, whether stops require the user leave the vehicle (e.g., to pick up or drop off a delivery), safety and/or risk associated with different potential routes, insurance costs associated with potential routes, predicted carbon emissions associated with different potential routes, and/or other factors that may vary depending on the specific route selected. The server computing device may select the generated route based in part upon optimizing one or more of these factors. In some embodiments, the server computing device may generate multiple routes that prioritize different ones of these factors (e.g., a shortest distance and a shortest predicted duration), and the user may select from among the generated routes.

In certain embodiments, the AI model may be configured to generate recommendations of trip assignments for a user based upon trip assignment information, driver information associated with the user, and other contextual information such as that described above with respect to generating a route. For example, the AI model may generate recommendations for which trip assignments for the driver to select that are being offered by the same or different trip assignment providers so as to maximize the driver's delivery efficiency, maximize payment and/or minimize risk to the driver and/or any other preference the driver may wish to input into the system.

These recommendations may be presented with proposed generated routes. For example, the AI model may generate trip assignment recommendations based upon a current location of a driver and other information, and then generate different recommended routes for different combinations of these recommended trip assignments from which the user may select. The recommended routes may be presented via the application along with expected earnings (e.g., from fares or delivery charges), costs, milage, time, and/or other information relevant to selecting a route. In these cases, the user may not need to select specific trip assignments via the application, and trip assignments included in a recommended route may automatically be selected if the user selects the corresponding recommended route.

In some embodiments, to generate the route, the server computing device may consider user preferences as determined by trends over time. In some embodiments, the server computing device may infer or predict preferences of the user based upon user profile data. For example, preferences that may be considered include historical patterns indicating the user desires to decrease costs, decrease travel time, decrease travel distance, reduce risk or increase safety, reduce insurance costs, reduce carbon emissions, and/or achieve other objectives with respect to travel. For example, if a user has historically opted to travel a route that is considered the safest even which such an option would result in a greater travel distance or longer trip time, the server computing device may give more weight to safety or risk when selecting a route. Additionally, certain predefined rules may be applied when determining a route. For example, the AI model may generate routes such that a passenger and food delivery order are not in the vehicle simultaneously.

In some embodiments, the server computing device may compute a predicted cost associated with the trip, which may include costs associated with operating the vehicle (e.g., fuel costs) and/or costs associated with insurance. For example, the server computing device may compute (e.g., using the AI model) a risk score associated with different possible routes. The risk or loss score may be determined based upon, for example, vehicle type, geographic location, driver history, trip assignment provider being used, driver-specific risk scores, choice of route within neighborhoods (e.g., whether the user is comfortable with riskier locations and/or unfamiliar with the risk of a location), passenger-specific risk score (e.g., based upon previous interactions and/or cumulative/ratings provided by driver of rideshare and/or claims behavior), and/or insurer-determined knowledge relating to risks of certain locations along the potential route. As described in further detail below, the cost or risk score may be computed based in part upon telematics data received from user devices during previous trip assignments.

The risk score may correspond to a likelihood of injury or financial loss occurring for a selected route, and may be used (e.g., by the server computing device) to compute an insurance premium for a route. This insurance premium may be factored in when determining a cost associated with a route. For example, consider two potential routes: Route A and Route B. Route A has a lower transportation cost (e.g., fuel cost) than Route B, but has a higher risk score and therefore a higher associated insurance cost than Route B. Accordingly, if the sum of the transportation cost and insurance cost of Route A is greater than the sum of the transportation cost and insurance cost of Route B, Route B may be selected despite Route B having a higher transportation cost. Accordingly, factoring insurance costs when selecting a route may result in safer travel patterns for the user over time while reducing overall costs of travel for the user.

In the exemplary embodiment, the server computing device may be configured to generate a user interface and cause the user device to display the user interface (e.g., within the mobile app). The user interface may include instructions associated with the generated route. For example, the instructions may include directions for following the route and/or indicate where to pick up and/or drop off passengers and/or delivery items. In some embodiments, such instructions may include text and/or language generated using AI and/or chatbot programs (e.g., ChatGPT).

In the exemplary embodiment, the server computing device may also be configured to track and store all assignments accepted and performed by the driver including across multiple transportation platform. By so doing, the system is able to determine and allocate insurance costs across multiple transportation assignment platforms based on the different deliveries being made by the driver. Moreover, if an accident does occur during a delivery, the system is configured to inform or notify one or more of the transportation platforms that are being used for a delivery at the time of the accident, and allocate costs/responsibilities between the platforms associated with the accident.

### Tracking Driving Using Telematics Data

In some embodiments the server computing device may be configured to collect information (e.g., telematics data) from sensors (e.g., of the user device, of tracking or identifier tags and/or vehicles communicatively linked to the mobile device). This telematics data may be used to determine when a user has completed a trip assignment, assess the user's driving while carrying out trip assignments, and for training and/or updating the AI model (e.g., for generating future routes or predicting future costs).

In some embodiments, the server computing device may be configured to determine a trip assignment has been completed based upon the telematics data. For example, based upon the telematics data, the server computing device may determine the user has reached the origin and destination locations. In some cases, additional data may be used to determine that a trip assignment has been completed. For example, using the application, the user may capture an image of a delivered item placed at a destination, or data retrieved from a user device associated with a passenger may be used to verify that the passenger has reached a destination. In some embodiments, the server computing device may provide telematics data to a trip assignment provider, which may determine whether a trip assignment has been completed based upon the data and return a corresponding indication of trip completion to the server computing device. In embodiments in which the server computing device determines locally whether a trip assignment has been completed, the server computing device may be configured to transmit a completion message indicating the trip assignment has been completed to the corresponding trip assignment provider.

In certain embodiments, the server computing device may be configured to compute a cost or score based upon the received telematics data. The cost or score may include, for example, a fare or delivery fee associated with the trip assignment, a predicted fuel cost, and/or a risk score that may be used to compute future insurance costs. The cost or score may be computed based upon, for example, a trip time, a length of the route actually taken, whether the route actually taken differs from the route generated by the AI model, expenses (e.g., fuel, tolls), acceleration, braking, speed, turning, locations or zones through which the user device passed, and/or other parameters that may be determined based upon the telematics data.

The server computing device may cause, using the application, the user device to display the computed cost or score. For example, the application may enable the user to track milage and expenses for time periods or individual trips, help the user estimate tax obligations. The application may also include suggestions for financial products and services, which may be generated by the AI model based upon driver information. As described above, the application may include a chatbot functionality, through which this information may be presented. For example, requests for information inputted as text and/or natural language may be analyzed using AI and/or chatbot programs (e.g., ChatGPT), which in some embodiments may generate text and/or natural language responses to be presented through the application.

In some embodiments, the server computing device may cause, using the application, the user device to present directions or instructions determined based upon a current location of the user device. For example, while traversing a route generated by the AI model, the application may present maps and/or turn-by-turn directions with corresponding audio, text, and/or video commands. The application may further present information and/or instructions relating to upcoming pick-ups and drop-offs, such as who are what is to be picked up, instructions for picking up an item, and/or instructions for verifying a drop-off has taken place (e.g., prompts to capture an image). These instructions may be generated based upon information exchanged in real time with the trip assignment providers. For example, the server computing device may determine a destination has been reached based upon telematics data, and forward this information to the corresponding trip assignment provider. In response, the trip assignment provider may request an image confirming the trip assignment has been complete, and the server computing device may then prompt the user via the application to capture this image.

In certain cases, data collected by the server computing device may be used in providing and/or coordinating insurance for the user during the trip assignments. By comparison, traditionally a user working for different trip assignment providers may be required to carry separate insurance for each provider, and therefore when the user is working on multiple trip assignments simultaneously, ambiguity may be created in which insurance policy should apply or how milage should be used to determine insurance premiums. By having access to information relating to all trip assignments carried out by a user, the server computing device may identify periods where multiple insurance policies may apply concurrently and apply rules to determine how these periods are handled by insurance (e.g., proper sharing of claim losses and/or fractional miles to split insurance costs between different insurers associated with different trip service providers). In some situations, a single usage-based insurance policy covering activity for multiple and/or all of the different trip assignment providers may be provided using data collected by the server computing device.

At least one of the technical problems addressed by this system may include: (i) inability of a computing device to generate a route covering multiple trip assignments received from different trip assignment providers; (ii) inability of a computing device to generate a route for multiple trip assignments based upon user preferences using an AI model trained based upon historical trip data including data relating to previously completed trip assignments; (iii) inability of a computing device to determine a potential cost, safety, or risk level of a route having multiple route using an AI model trained based upon historical trip data; and/or (iv) inability of a user interface to display instructions associated with a route associated with multiple trip assignments using an AI model trained based upon historical trip data.

The technical effect achieved by this system may be at least one of: (i) ability for a computing device to generate a route covering multiple trip assignments received from different trip assignment providers; (ii) ability for a computing device to generate a route for multiple trip assignments based upon user preferences using an AI model trained based upon historical trip data including data relating to previously completed trip assignments; (iii) ability for a computing device to determine a potential cost, safety, or risk level of a route having multiple route using an AI model trained based upon historical trip data; and/or (iv) ability for a user interface to display instructions associated with a route associated with multiple trip assignments using an AI model trained based upon historical trip data.

### Exemplary Transportation Analytics System

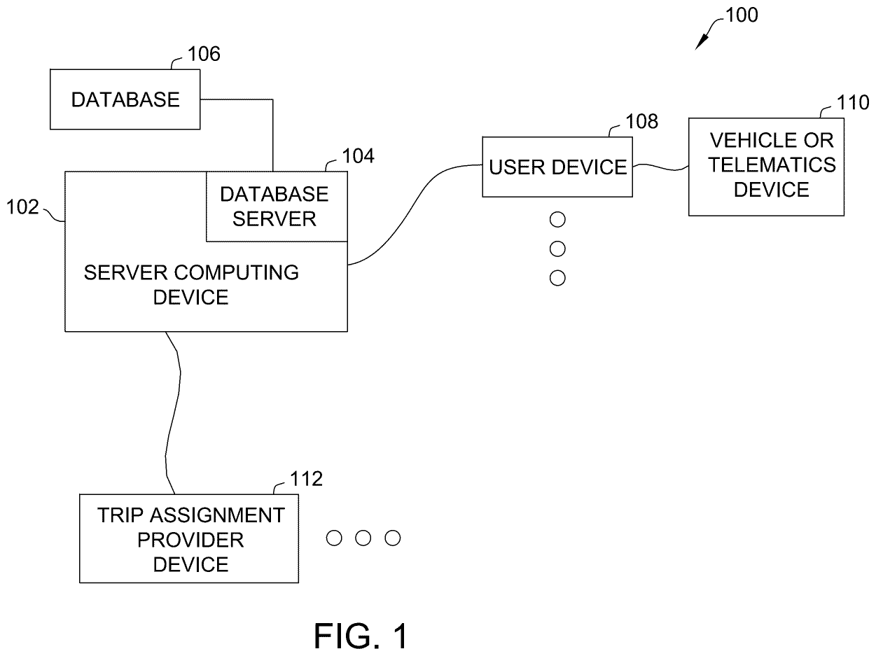

FIG. 1 depicts an exemplary computer system 100 for the present disclosure. Computer system 100 may include a server computing device 102 (which may include one or more computing devices and/or one or more processors) including a database server 104. Server computing device 102 may be in communication with a database 106 and/or one or more user devices 108 associated with one or more users. In some embodiments, user devices 108 may be configured to communicatively link (e.g., via Bluetooth and/or another wireless or wired connection) to vehicles and/or telematics devices 110. Server computing device 102 may be in further communication with one or more trip assignment provider devices 112.

In the exemplary embodiment, server computing device 102 may be configured to retrieve data that may be used to identify trip assignments to present to the user, and to generate a route for the user if the trip assignments are accepted. This data may include data relating to the user (referred to herein as “driver information”), data relating to specific trip assignments (referred to herein as “trip assignment information”), which may be provided by one or more trip assignment provider devices 112 in communication with server computing device 102, and other contextual data (e.g., a current location of the user, road, traffic, and weather data, etc.).

The driver information may include trip assignment providers and associated trip assignment provider devices 112 with which the user has registered, preferences to use certain types of transportation, age, health information, demographic information, historical trips and trip patterns, historical usage of different types of transportation, frequently visited locations, historical accident information, historical events and/or claims, and/or preferred billing option. The driver information may be retrieved from a database, the Internet, and/or other sources capable of providing such data. For example, user profiles including driver information may be stored for each user in the database. The driver information may be entered by the user (e.g., via a preferences and/or settings interface of the mobile app), automatically compiled based upon historical trips, and/or automatically retrieved from other data sources (e.g., insurance, financial, and/or trip assignment provider accounts linked to the user profile and/or associated with the user). In some embodiments, the mobile app may initially autofill the user profile with automatically compiled driver information and allow the user to manually make changes to the information.

The driver information may further include historical telematics data (e.g., acceleration, cornering, braking, position, velocity, orientation, speed, location, GPS location or other GPS information, etc.) associated with previous trips taken by the user. The telematics data may be collected by sensors of the mobile device, sensors of vehicles and/or telematics devices 110 communicatively linked to the mobile device during trips (e.g., via Bluetooth and/or another wired or wireless communication protocol), and/or trip assignment provider accounts (e.g., rideshare driver accounts) linked to the user profile that may collect and/or store telematics data during trips. The user profile may further include user feedback from previous trips. For example, the mobile app may prompt the user to rate a trip upon completion of the trip, and over time, server computing device 102 may identify aspects of a trip that are preferred by the user based upon the submitted ratings.

The server computer device may receive from a plurality of trip assignment provider devices 112 trip assignment information. This trip assignment information may include information relating to specific trip assignments (e.g., rideshare and/or delivery requests) provided by trip assignment provider devices 112 in response to requests from customers associated with trip assignment provider devices 112. For example, the trip assignment information may include an origin and destination for a requested trip, waypoints, a trip type (e.g., rideshare, food delivery, parcel delivery, etc.), and a time for the trip assignment (e.g., whether immediate or at a future time and/or a time at which completion of the trip assignment is due). The trip assignment information may be used by server computing device 102 to determine to which users to present the trip assignments (e.g., users that are in an appropriate geographic area and/or have registered with the trip assignment provider corresponding to the trip). The trip assignment information may further be utilized by server computing device 102 for generating routes. For example, a generated route should pass though the origin and then the destination of a trip assignment accepted by a user.

In some embodiments, server computing device 102 may further retrieve geographic data based upon which the route may be generated. The geographic data may include data describing topography, locations or thoroughfares such as highways, roads, bike paths, trails, and sidewalks, mass transit routes, safety statistics (e.g., rates of traffic collisions and/or crime), and zones in which certain transportation services such as rideshares, bikeshares, and/or electric scooters are available. The geographic data may be retrieved from a database, the Internet (e.g., from third-party mapping services, such as Google Maps), and/or other sources capable of providing such data, and may be periodically or continually updated to reflect a current state.

In some embodiments, server computing device 102 may further retrieve contextual data, or data describing current or real-time conditions, based upon which the route may be generated. The contextual data may include data describing traffic conditions, road conditions (e.g., construction), major events that may affect traffic flow (e.g., locations of conventions, concerts and/or sporting events), weather, time of day, time of year, or other conditions that may affect travel. The contextual data may be retrieved from a database, the Internet (e.g., from third-party mapping services, such as Google Maps), and/or other sources capable of providing such data, and may be periodically or continually updated (e.g., in real time) to reflect current conditions. As described in further detail below, server computing device 102 may be configured to update generated routes in real time (e.g., after travel has started) if contextual data indicates that conditions have changed from when the route was initially generated.

In the exemplary embodiment, server computing device 102 may cause, using an application executing on user device 108 of a user, user device 108 to display a plurality of trip assignments. The plurality of trip assignments may each be associated with a respective trip assignment provider device 112.

Server computing device 102 may select trip assignments to present to a user based upon the trip assignment information associated with available trip assignments and driver information associated with the user. For example, server computing device may identify trip assignments originating from trip assignment provider devices 112 with which the user has registered and meet other user preferences (e.g., input by the user and/or otherwise identified by server computing device 102). Examples of such preferences may include a geographic zone, maximum distance form a current location of the user, trip assignment type (e.g., rideshare versus delivery), time by which the trip assignment must be completed, expected length of the trip, and/or other such factors. Additionally, some of this information may be displayed by user device 108 executing the application along with each displayed trip assignment to assist the user in selecting which trip assignments to accept.

The user may select one or more trip assignments to accept via the application, and user device 108 may transmit this selection to server computing device 102. The accepted trip assignments do not need to originate from the same trip assignment provider device 112 and/or type of trip provider. For example, the user may select two trip assignments originating from different rideshare services and/or one trip assignment from a rideshare service and one trip assignment from a food delivery service concurrently. Server computing device 102 may transmit an acceptance message to trip assignment provider devices 112 that are associated with the selected trip assignments. As described in further detail below, server computing device 102 may generate a route for the user based upon the selected trip assignments. By combining an ability to accept multiple trip assignments, which may originate from different trip assignment provider devices 112, within a single application may simplify the process of using different trip assignment providers simultaneously and therefore may reduce distracted driving by users accepting multiple trip assignments (e.g., as compared to using multiple different apps and/or user devices).

In some embodiments, the application may include a chatbot functionality, through which the user may be presented and/or accept trip assignments, request a route, and/or request other information using text and/or natural language. Such text and/or natural language inputs may be analyzed using AI and/or chatbot programs (e.g., ChatGPT), which in some embodiments may generate text and/or natural language responses to be presented through the application.

In certain embodiments, the application may provide a portal through which the user may register with trip assignment provider devices 112. A described above, the user may create a login account. Through the application, the user may enter or upload information that may be used to apply to different trip assignment providers, such as proof of insurance and/or drivers license information. The application may present a list of available trip service providers to which the user may apply (e.g., those operating in a geographic area of the user and/or likely to accept the user based upon the provided information), and the user may select trip service providers to apply. Server computing device 102 may transmit this application to the selected trip service providers, which may accept the user's application based upon the submitted information and/or other information (e.g., a background check). Trip assignment provider devices 112 may then report this acceptance to server computing device 102, which may then record that the user has been registered with the accepting trip assignment providers. In some embodiments, trip assignment provider devices 112 may present, via push notifications or other message displayed by and/or within the application, information such as promotions, bonuses, or other perks to certain users who may qualify (e.g., those in a certain geographic area).

In the exemplary embodiment, server computing device 102 may be configured to generate an AI model, also referred to herein as a route generating model, that may used to generate routes based upon trip assignment information, driver information, and/or other contextual information. In some embodiments, server computing device 102 may generate and/or train the route generating model using a training dataset that includes one or more training variables and/or model parameters, such as historical geographic data, historical contextual data, historical trip assignment information, and/or historical driver information.

In other embodiments, server computing device 102 may generate the route generating model in a different format. For example, the route generating model may be a function for receiving data (e.g., an origin and destination associated with a trip assignment, geographic data, contextual data, and user profile data) and generating an output for determining a route.

Server computing device 102 may be configured to generate the route generating model by analyzing historical trip records including historical trip assignment information (e.g., historical destinations, routes, types of transportation used, telematics data, costs, user feedback, and/or events such as collisions and/or injuries occurring during the trip) associated with historical trips. Server computing device 102 may be configured to perform a statistical analysis of the historical trip records to generate the structure assessment model. For example, for an aspect of a historical trip (e.g., destinations, routes, types of transportation used, telematics data, costs, user feedback, and/or events such as collisions and/or injuries that occurred during the trip), server computing device 102 may identify historical trip records associated with the aspect and generate model parameters (e.g., by identifying other parameters held in common among the identified historical trip records). For example, server computing device 102 may identify features correlated with a particular historical pattern. In other embodiments, server computing device 102 may be configured to perform a different analysis that is suitable to generate the route generating model.

The route generating model may be associated with and/or include a parametric engine. The parametric engine represents a relationship between input data such as training variables and/or predicted outputs. The training variables may be parameterized allowing the parametric engine to be tuned to generate accurate outputs. Parameterized training variables may be weighted using weighting coefficients. The parametric engine may be tuned to determine a magnitude and/or a direction of the weighting coefficients. Tuning may include iteratively using the parametric engine to generate model outputs that correspond to an actual event, such as a historical trip, while adjusting the magnitude and direction of the weight coefficients until the error between the model output and the actual event is reduced to an acceptable level. Tuning may be performed in addition to, and/or in combination with, training the model using historical data.

The parametric engine may use the weighted coefficients to rank an importance or influence of a model training variable. For example, if the weighting factor is greater, the greater the importance server computing device 102 will associate with that variable when tuning the model. Likewise, the smaller the weighting factor, the lesser the importance that server computing device 102 will associate with the variable when tuning the model. In some embodiments, server computing device 102 may weight variables associated with the historical trip records greater than any other model training variables.

In some embodiments, server computing device 102 may use a reduced number of training variables (e.g., one or more training variables) that have the greatest weighting factors (e.g., the variables that are ranked with the most importance). The reduced and more focused training dataset, including the training variables with the greatest weights, decreases computational load and will have decreased model training time allowing the model to be more quickly updated as more historical image records are created and added to the subset training dataset. Server computing device 102 may generate a training dataset including less than a particular number (e.g., five or three) model training variables, for example.

In the exemplary embodiment, server computing device 102 may be further configured to generate routes based upon selected trip assignments and their corresponding trip assignment information using the trained AI model. The generated route may include a path that, for each trip assignment, connects the corresponding origin and destination. In some cases, the trip assignments may overlap in time. For example, for two trip assignments “A” and “B,” the generate route may first pass though an origin of trip assignment A and an origin of trip assignment B, and then pass trough a destination of trip assignment A and end at a destination of trip assignment B. As described in further detail below, the AI model may apply certain rules to determine when trip assignments can or cannot overlap. The generated route may be selected to achieve a greater or maximized expected earnings for the user, reduced or minimized time (e.g., overall time and/or time to complete each trip assignment), reduced or minimal distance or milage, reduced or minimal fuel consumption, and/or achieve some balance between these and/or other factors. In some embodiments, server computing device 102 may update and/or make changes to the route in real time (e.g., after the trip has started) based upon new data (e.g., data indicating traffic conditions have changed and/or service outages have occurred at a given location).

In some embodiments, the route may be generated by the AI model based upon driver information and other contextual data. This information may include, for example, predicted supply and demand for different types of trip assignments (e.g., whether there are few or many other drivers and/or people seeking transportation or deliveries in the area), user preferences as determined by trends over time, predicted trip durations associated with different potential routes, predicted trip lengths associated with different potential routes, predicted trip costs (e.g., insurance costs) associated with different potential routes, types of trip assignments (e.g., rideshare versus deliveries), numbers of stops, whether stops require the user leave the vehicle (e.g., to pick up or drop off a delivery), safety and/or risk associated with different potential routes, insurance costs associated with potential routes, predicted carbon emissions associated with different potential routes, and/or other factors that may vary depending on the specific route selected. Server computing device 102 may select the generated route based in part upon optimizing one or more of these factors. In some embodiments, server computing device 102 may generate multiple routes that prioritize different ones of these factors (e.g., a shortest distance and a shortest predicted duration), and the user may select from among the generated routes.

In certain embodiments, the AI model may be configured to generate recommendations of trip assignments for a user based upon trip assignment information, driver information associated with the user, and other contextual information such as that described above with respect to generating a route. For example, the AI model may generate recommendations for which trip assignments for the driver to select that are being offered by the same or different trip assignment providers so as to maximize the driver's delivery efficiency, maximize payment and/or minimize risk to the driver and/or any other preference the driver may wish to input into the system.

These recommendations may be presented with proposed generated routes. For example, the AI model may generate trip assignment recommendations based upon a current location of a driver and other information, and then generate different recommended routes for different combinations of these recommended trip assignments from which the user may select. The recommended routes may be presented via the application along with expected earnings (e.g., from fares or delivery charges), costs, milage, time, and/or other information relevant to selecting a route. In these cases, the user may not need to select specific trip assignments via the application, and trip assignments included in a recommended route may automatically be selected if the user selects the corresponding recommended route.

In some embodiments, to generate the route, server computing device 102 may consider user preferences as determined by trends over time. In some embodiments, server computing device 102 may infer or predict preferences of the user based upon user profile data. For example, preferences that may be considered include historical patterns indicating the user desires to decrease costs, decrease travel time, decrease travel distance, reduce risk or increase safety, reduce insurance costs, reduce carbon emissions, and/or achieve other objectives with respect to travel. For example, if a user has historically opted to travel a route that is considered the safest even which such an option would result in a greater travel distance or longer trip time, server computing device 102 may give more weight to safety or risk when selecting a route. Additionally, certain predefined rules may be applied when determining a route. For example, the AI model may generate routes such that a passenger and food delivery order are not in the vehicle simultaneously.

In some embodiments, server computing device 102 may compute a predicted cost associated with the trip, which may include costs associated with operating the vehicle (e.g., fuel costs) and/or costs associated with insurance. For example, server computing device 102 may compute (e.g., using the AI model) a risk score associated with different possible routes. The risk or loss score may be determined based upon, for example, vehicle type, geographic location, driver history, trip assignment provider being used, driver-specific risk scores, choice of route within neighborhoods (e.g., whether the user is comfortable with riskier locations and/or unfamiliar with the risk of a location), passenger-specific risk score (e.g., based upon previous interactions and/or cumulative/ratings provided by driver of rideshare and/or claims behavior), and/or insurer-determined knowledge relating to risks of certain locations along the potential route. As described in further detail below, the cost or risk score may be computed based in part upon telematics data received from user devices during previous trip assignments.

The risk score may correspond to a likelihood of injury or financial loss occurring for a selected route, and may be used (e.g., by server computing device 102) to compute an insurance premium for a route. This insurance premium may be factored in when determining a cost associated with a route. For example, consider two potential routes: Route A and Route B. Route A has a lower transportation cost (e.g., fuel cost) than Route B, but has a higher risk score and therefore a higher associated insurance cost than Route B. Accordingly, if the sum of the transportation cost and insurance cost of Route A is greater than the sum of the transportation cost and insurance cost of Route B, Route B may be selected despite Route B having a higher transportation cost. Accordingly, factoring insurance costs when selecting a route may result in safer travel patterns for the user over time while reducing overall costs of travel for the user.

In the exemplary embodiment, server computing device 102 may be configured to generate a user interface and cause user device 108 to display the user interface (e.g., within the mobile app). The user interface may include instructions associated with the generated route. For example, the instructions may include directions for following the route and/or indicate where to pick up and/or drop off passengers and/or delivery items. In some embodiments, such instructions may include text and/or language generated using AI and/or chatbot programs (e.g., ChatGPT).

In some embodiments server computing device 102 may be configured to collect information (e.g., telematics data) from sensors (e.g., of user device 108, of tracking or identifier tags and/or vehicles communicatively linked to the mobile device). This telematics data may be used to determine when a user has completed a trip assignment, assess the user's driving while carrying out trip assignments, and for training and/or updating the AI model (e.g., for generating future routes or predicting future costs).

In some embodiments, server computing device 102 may be configured to determine a trip assignment has been completed based upon the telematics data. For example, based upon the telematics data, server computing device 102 may determine the user has reached the origin and destination locations. In some cases, additional data may be used to determine that a trip assignment has been completed. For example, using the application, the user may capture an image of a delivered item placed at a destination, or data retrieved from a user device associated with a passenger may be used to verify that the passenger has reached a destination. In some embodiments, server computing device 102 may provide telematics data to a trip assignment provider device 112, which may determine whether a trip assignment has been completed based upon the data and return a corresponding indication of trip completion to server computing device 102. In embodiments in which server computing device 102 determines locally whether a trip assignment has been completed, server computing device 102 may be configured to transmit a completion message indicating the trip assignment has been completed to the corresponding trip assignment provider device 112.

In certain embodiments, server computing device 102 may be configured to compute a cost or score based upon the received telematics data. The cost or score may include, for example, a fare or delivery fee associated with the trip assignment, a predicted fuel cost, and/or a risk score that may be used to compute future insurance costs. The cost or score may be computed based upon, for example, a trip time, a length of the route actually taken, whether the route actually taken differs from the route generated by the AI model, expenses (e.g., fuel, tolls), acceleration, braking, speed, turning, locations or zones through which user device 108 passed, and/or other parameters that may be determined based upon the telematics data.

Server computing device 102 may cause, using the application, user device 108 to display the computed cost or score. For example, the application may enable the user to track milage and expenses for time periods or individual trips, help the user estimate tax obligations. The application may also include suggestions for financial products and services, which may be generated by the AI model based upon driver information. As described above, the application may include a chatbot functionality, through which this information may be presented. For example, requests for information inputted as text and/or natural language may be analyzed using AI and/or chatbot programs (e.g., ChatGPT), which in some embodiments may generate text and/or natural language responses to be presented through the application.

In some embodiments, server computing device 102 may cause, using the application, user device 108 to present directions or instructions determined based upon a current location of user device 108. For example, while traversing a route generated by the AI model, the application may present maps and/or turn-by-turn directions with corresponding audio, text, and/or video commands. The application may further present information and/or instructions relating to upcoming pick-ups and drop-offs, such as who are what is to be picked up, instructions for picking up an item, and/or instructions for verifying a drop-off has taken place (e.g., prompts to capture an image). These instructions may be generated based upon information exchanged in real time with trip assignment provider devices 112. For example, server computing device 102 may determine a destination has been reached based upon telematics data, and forward this information to the corresponding trip assignment provider device 112. In response, the trip assignment provider device 112 may request an image confirming the trip assignment has been complete, and server computing device 102 may then prompt the user via the application to capture this image.

In certain cases, data collected by server computing device 102 may be used in providing and/or coordinating insurance for the user during the trip assignments. By comparison, traditionally a user working for different trip assignment providers may be required to carry separate insurance for each provider, and therefore when the user is working on multiple trip assignments simultaneously, ambiguity may be created in which insurance policy should apply or how milage should be used to determine insurance premiums. By having access to information relating to all trip assignments carried out by a user, server computing device 102 may identify periods where multiple insurance policies may apply concurrently and apply rules to determine how these periods are handled by insurance (e.g., proper sharing of claim losses and/or fractional miles to split insurance costs between different insurers associated with different trip service providers). In some situations, a single usage-based insurance policy covering activity for multiple and/or all of the different trip assignment providers may be provided using data collected by server computing device 102.

### Exemplary Client Computing Device

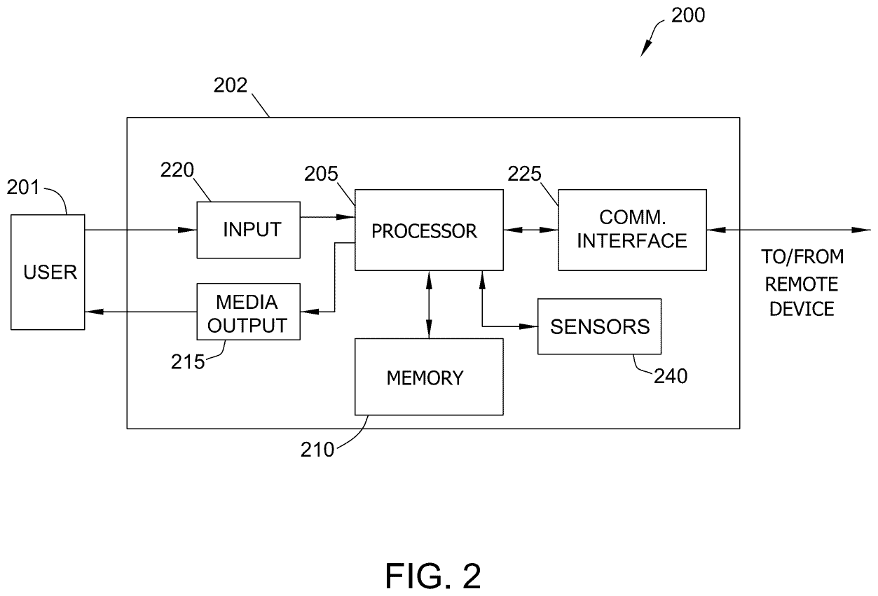

FIG. 2 depicts an exemplary client computing device 202. Client computing device 202 may be, for example, at least one of user device 108, vehicle and/or telematics device 110, and/or trip assignment provider device 112 (all shown in FIG. 1).

Client computing device 202 may include a processor 205 for executing instructions. In some embodiments, executable instructions may be stored in a memory area 210. Processor 205 may include one or more processing units (e.g., in a multi-core configuration). Memory area 210 may be any device allowing information such as executable instructions and/or other data to be stored and retrieved. Memory area 210 may include one or more computer readable media.

In certain exemplary embodiments, client computing device 202 may also include at least one media output component 215 for presenting information to a user 201. Media output component 215 may be any component capable of conveying information to user 201. In some embodiments, media output component 215 may include an output adapter such as a video adapter and/or an audio adapter. An output adapter may be operatively coupled to processor 205 and operatively couplable to an output device such as a display device (e.g., a liquid crystal display (LCD), light emitting diode (LED) display, organic light emitting diode (OLED) display, cathode ray tube (CRT) display, “electronic ink” display, or a projected display) or an audio output device (e.g., a speaker or headphones).

Client computing device 202 may also include an input device 220 for receiving input from user 201. Input device 220 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 215 and input device 220.

Client computing device 202 may also include a communication interface 225, which can be communicatively coupled to a remote device such as server computing device 102 (shown in FIG. 1). Communication interface 225 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

In some embodiments, client computing device 202 may also include sensors 240. Sensors 240 may include, for example, an accelerometer, a global positioning system (GPS), or a gyroscope. Sensors 240 may be used to collect telematics data, which may be transmitted by client computing device 202 a remote device such as server computing device 102 (shown in FIG. 1).

Stored in memory area 210 may be, for example, computer readable instructions for providing a user interface to user 201 via media output component 215 and, optionally, receiving and processing input from input device 220. A user interface may include, among other possibilities, a web browser and client application. Web browsers may enable users, such as user 201, to display and interact with media and other information typically embedded on a web page or a website. A client application may allow user 201 to interact with a server application from server computing device 102 (shown in FIG. 1).

Memory area 210 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

### Exemplary Server System

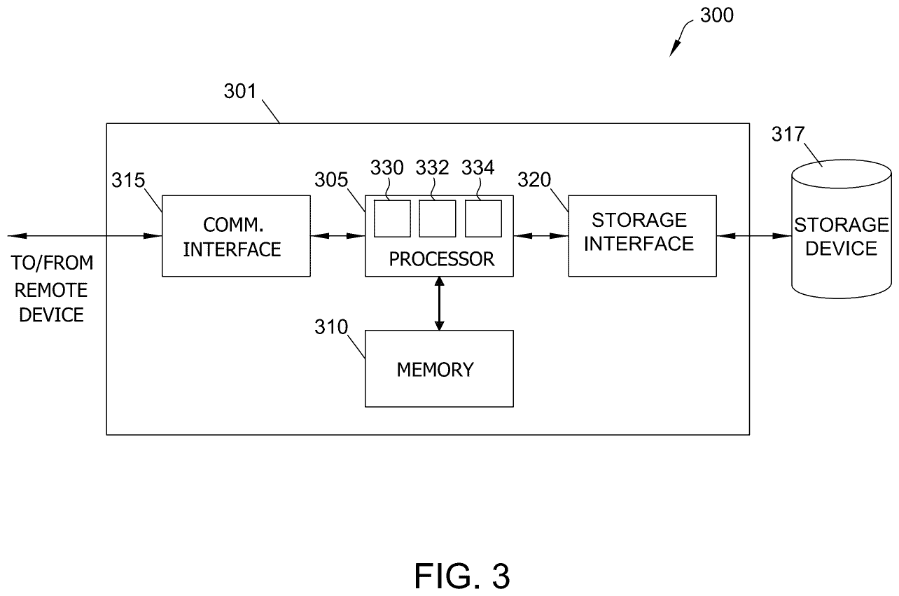

FIG. 3 depicts an exemplary server system that may be used with computer system 100 illustrated in FIG. 1. Server system 301 may be, for example, server computing device 102 and/or trip assignment provider device 112 (shown in FIG. 1).

In exemplary embodiments, server system 301 may include a processor 305 for executing instructions. Instructions may be stored in a memory area 310. Processor 305 may include one or more processing units (e.g., in a multi-core configuration) for executing instructions. The instructions may be executed within a variety of different operating systems on server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 may be operatively coupled to a communication interface 315 such that server system 301 is capable of communicating with user device 108 and/or vehicle and/or telematics device 110 (all shown in FIG. 1), or another server system 301. For example, communication interface 315 may receive requests from user device 108 via the Internet. Further, processor 305, via communication interface 315, may be capable of causing funds to be transferred between various entities, such as, for example, accounts associated with user device 108 and/or trip assignment provider device 112 (all shown in FIG. 1).

Processor 305 may also be operatively coupled to a storage device 317, such as database 106 (shown in FIG. 1). Storage device 317 may be any computer-operated hardware suitable for storing and/or retrieving data. In some embodiments, storage device 317 may be integrated in server system 301. For example, server system 301 may include one or more hard disk drives as storage device 317.

In other embodiments, storage device 317 may be external to server system 301 and may be accessed by a plurality of server systems 301. For example, storage device 317 may include multiple storage units such as hard disks or solid state disks in a redundant array of inexpensive disks (RAID) configuration. Storage device 317 may include a storage area network (SAN) and/or a network attached storage (NAS) system.

In some embodiments, processor 305 may be operatively coupled to storage device 317 via a storage interface 320. Storage interface 320 may be any component capable of providing processor 305 with access to storage device 317. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 317.

In exemplary embodiments, processor 305 may include and/or be communicatively coupled to one or more modules for implementing the systems and methods described herein. For example, in some embodiments, processor 305 may include a machine learning module 330 configured to execute machine learning functions, a communication module 332 configured to facilitate communication with other computing devices, and/or an analytics module 334 configured to make determinations based upon data.

Memory area 310 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

### Exemplary Transportation Device

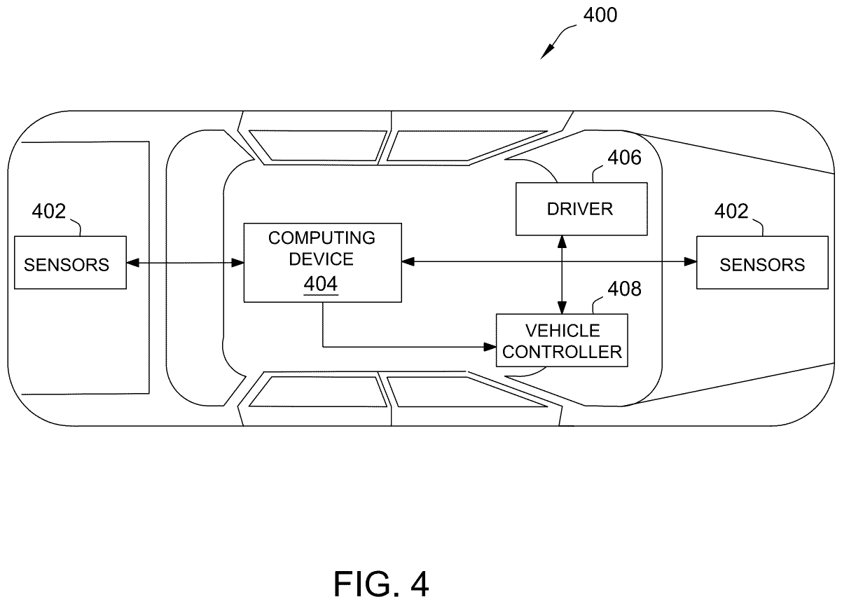

FIG. 4 depicts an exemplary transportation device 400. Transportation device 400 may be, for example, vehicle 110. In some embodiments, transportation device 400 may be a conventional and/or autonomous automobile, a motorcycle, a bicycle, a powered scooter (e.g., an electric scooter), a bus, a train, a boat, an aircraft, and/or another type of vehicle.

Transportation device 400 may include a plurality of sensors 402 and a computing device 404. Sensors 402 may include, but are not limited to, temperature sensors, terrain sensors, weather sensors, accelerometers, gyroscopes, radar, LIDAR, Global Positioning System (GPS), video devices, imaging devices, cameras (e.g., 2D and 3D cameras), audio recorders, and computer vision. In some embodiments, sensors 402 may be used to collect, for example, vehicle telematics data, as described above. In addition, sensors 402 may be used to collect additional information, for example, whether any external devices (e.g., user device 108) are communicatively linked to and/or otherwise in proximity to transportation device 400.

Such telematics data and/or sensor data collected by sensors 402 may be transmitted to server computing device 102 (shown in FIG. 1). The telematics data may be transmitted, for example, via user device 108 (shown in FIG. 1), which may be communicatively linked to transportation device 400 (e.g., via a physical dock and/or a wireless connection). Additionally or alternatively, transportation device 400 may be configured to communicate directly with server computing device 102.

Computing device 404 may be implemented, for example, as client computing device 202 (shown in FIG. 2). In exemplary embodiments, computing device 404 may receive data from sensors 402. In certain embodiments where server computing device 102 is remote from transportation device 400, computing device 404 may transmit data received from sensors 402 (e.g., vehicle telematics data) to server computing device 102. Alternatively, server computing device 102 may be implemented as computing device 404 and/or computing device 404 may execute some or all of the functions described with respect to server computing device 102.

In exemplary embodiments, vehicle controller 408 may control at least some operation of transportation device 400. For example, vehicle controller 408 may steer, accelerate, or decelerate transportation device 400 based upon data received, for example, from sensors 402. In some embodiments, vehicle controller 408 may include a display screen or touchscreen (not shown) that is capable of displaying information to and/or receiving input from driver 406.

In other embodiments, vehicle controller 408 may be capable of wirelessly communicating with a user mobile device such as user device 108 in transportation device 400. In these embodiments, vehicle controller 408 may be capable of communicating with the user of user device 108, such as driver 406, through an application on user device 108. In some embodiments, computing device 404 may include vehicle controller 408.

### Exemplary Method for Automated Route Generation

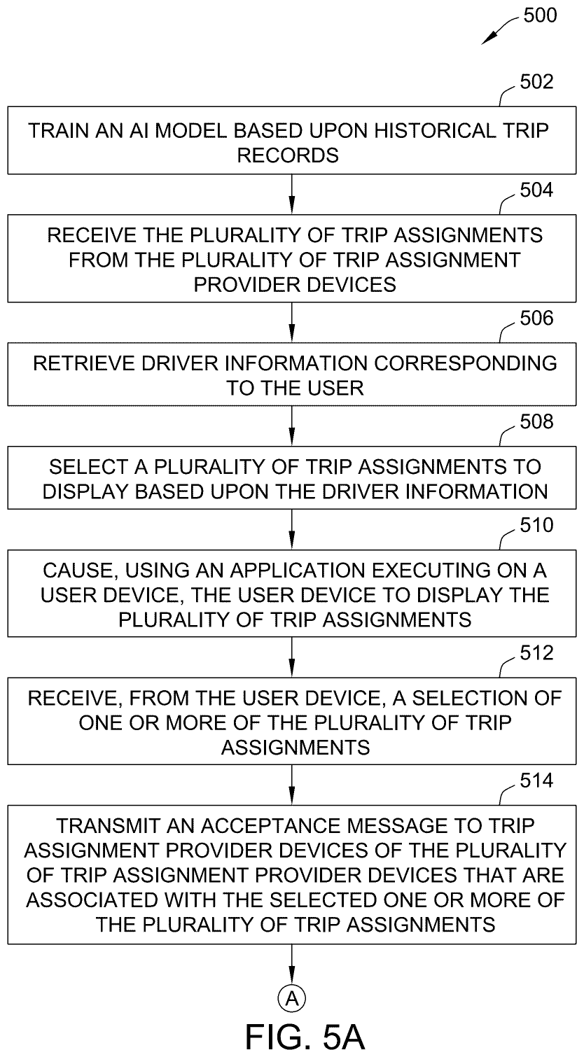

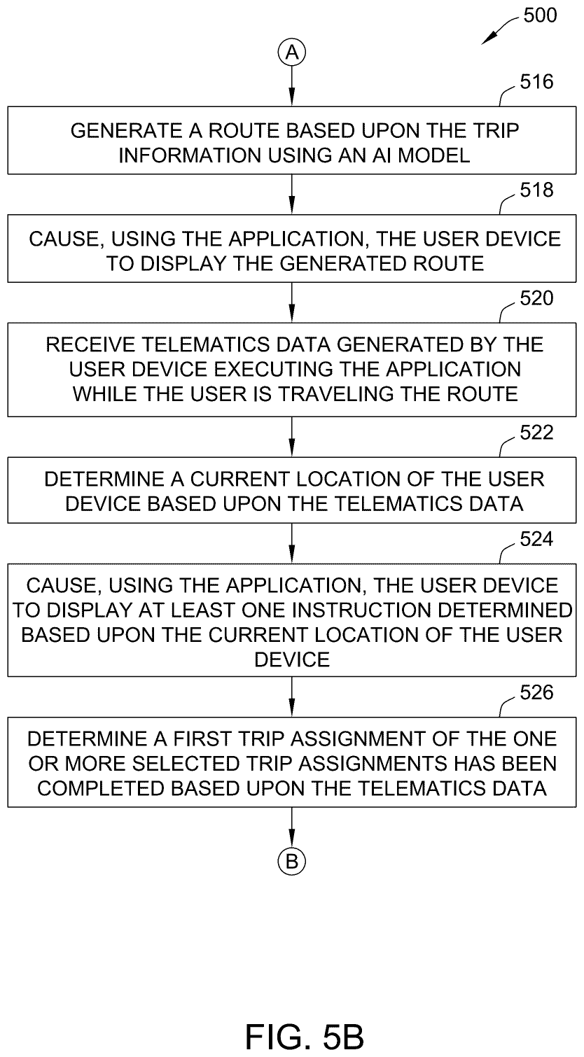

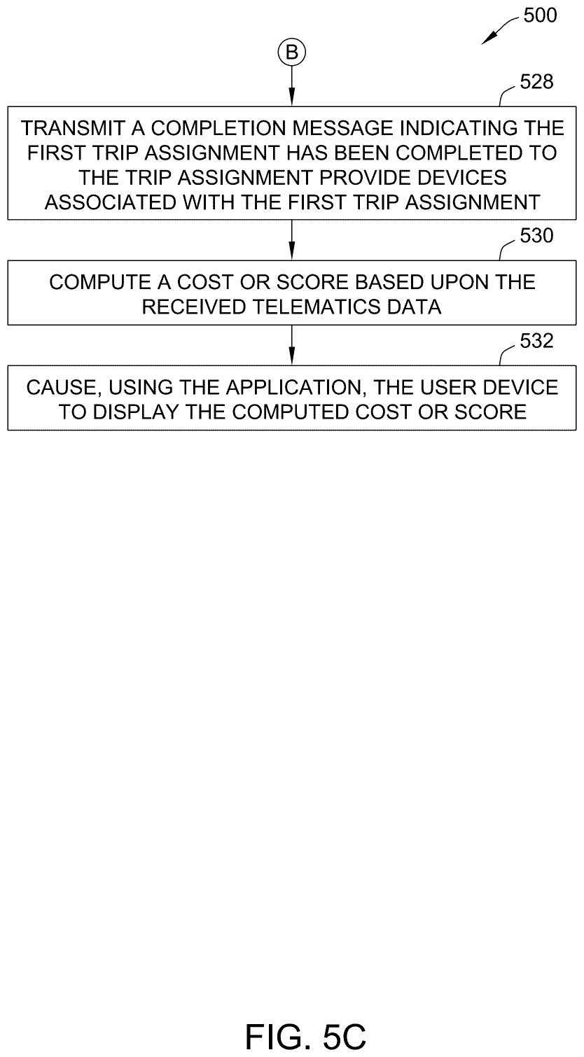

FIGS. 5A, 5B, and 5C are flowcharts that illustrate an exemplary computer-implemented method 500 for AI-based route generation. Computer-implemented method 500 may be performed by one or more components of computer system 100 (shown in FIG. 1), such as server computing device 102.

In certain embodiments, method 500 may include training (block 502) an AI model based upon historical trip records. In some embodiments, the training may be performed by server computing device 102, for example, by executing machine learning module 330 (shown in FIG. 3).

In some embodiments, method 500 may include receiving (block 504) the plurality of trip assignments from the plurality of trip assignment provider devices. In some embodiments, the receiving may be performed by server computing device 102, for example, by executing communication module 332 (shown in FIG. 3).

In certain embodiments, method 500 may include retrieving (block 506) driver information corresponding to the user. The driver information may indicate trip assignment provider devices with which the user has registered. In some such embodiments, method 500 may further include selecting (block 508) a plurality of trip assignments to display based upon the driver information. Each of the plurality of trip assignments may be associated with a trip assignment provider device of a plurality of trip assignment provider devices. In some embodiments, the retrieving and selecting may be performed by server computing device 102, for example, by executing communication module 332 and/or analytics module 334 (shown in FIG. 3).

In the example embodiment, method 500 may further include causing (block 510), using an application executing on a user device, the user device to display the plurality of trip assignments. In some embodiments, the causing may be performed by server computing device 102, for example, by executing communication module 332 (shown in FIG. 3).

In the example embodiment, method 500 may further include receiving (block 512), from the user device, a selection of one or more of the plurality of trip assignments. Each of the one or more selected trip assignments may include trip information including at least an origin and a destination. In some embodiments, the receiving may be performed by server computing device 102, for example, by executing communication module 332 (shown in FIG. 3).

In certain embodiments, method 500 may further include transmitting (block 514) an acceptance message to trip assignment provider devices of the plurality of trip assignment provider devices that are associated with the selected one or more of the plurality of trip assignments. In some embodiments, the transmitting may be performed by server computing device 102, for example, by executing communication module 332 (shown in FIG. 3).

In the example embodiment, method 500 may further include generating (block 516) an optimal route based upon the trip information using an AI model. The optimal route may include each origin and each destination associated with of the one or more selected trip assignments. In some embodiments, the generating may be performed by server computing device 102, for example, by executing machine learning module 330 (shown in FIG. 3).

In the example embodiment, method 500 may further include causing (block 518), using the application, the user device to display the generated optimal route. In some embodiments, the causing may be performed by server computing device 102, for example, by executing communication module 332 (shown in FIG. 3).

In some embodiments, method 500 may further include receiving (block 520) telematics data generated by the user device executing the application while the user is traveling the optimal route. In some embodiments, the receiving may be performed by server computing device 102, for example, by executing communication module 332 (shown in FIG. 3).

In certain such embodiments, method 500 may further include determining (block 522) a current location of the user device based upon the telematics data. In such embodiments, method 500 may further include causing (block 524), using the application, the user device to display at least one instruction determined based upon the current location of the user device. In some embodiments, the determining and causing may be performed by server computing device 102, for example, by executing analytics module 334 and/or communication module 332 (shown in FIG. 3).

In some such embodiments, method 500 may further include determining (block 526) a first trip assignment of the one or more selected trip assignments has been completed based upon the telematics data. In such embodiments, method 500 may further include transmitting (block 528) a completion message indicating the first trip assignment has been completed to the trip assignment provider devices associated with the first trip assignment. In some embodiments, the determining and transmitting may be performed by server computing device 102, for example, by executing analytics module 334 and/or communication module 332 (shown in FIG. 3).

In certain such embodiments, method 500 may further include computing (block 530) a cost or score based upon the received telematics data. In such embodiments, method 500 may further include causing (532), using the application, the user device to display the computed cost or score. In some embodiments, the computing and causing may be performed by server computing device 102, for example, by executing machine learning module 330 and/or communication module 332 (shown in FIG. 3).

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, server computing device 102 is configured to implement machine learning, such that server computing device 102 “learns” to analyze, organize, and/or process data without being explicitly programmed. Machine learning may be implemented through machine learning (“ML”) methods and algorithms (“ML methods and algorithms”). In one exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to telematics data and user input received from user device 108 and/or vehicle and/or telematics device 110. ML outputs may include but are not limited to insurance premium amounts calculated based upon the received telematics data. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of conversation data with known characteristics or features. Such information may include, for example, information associated with a plurality of different speaking styles and accents.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

Based upon these analyses, the processing element may learn how to identify characteristics and patterns that may then be applied to analyzing telematics data. For example, the processing element may learn, with the user's permission or affirmative consent, to identify an amount of risk associated with the user's actual transportation behavior. This information may be used to calculate an insurance premium based upon the user's transportation activity.

In some embodiments, the voice bots or chatbots discussed herein may be configured to utilize AI and/or ML techniques. For instance, the voice bot or chatbot may be a ChatGPT chatbot. The voice bot or chatbot may employ supervised or unsupervised machine learning techniques, which may be followed by and/or used in conjunction with reinforced or reinforcement learning techniques. The voice bot or chatbot may employ the techniques utilized for ChatGPT. The voice bot or chatbot may deliver various types of output for user consumption in certain embodiments, such as verbal or audible output, a dialogue output, text or textual output (such text or graphics presented on a computer or mobile device screen or display), visual or graphical output, and/or other types of outputs.

For the purposes of this discussion, a chatbot or chatterbot is a software application used to conduct an online chat conversation via text or text-to-speech, in lieu of providing direct contact with a live human agent. Chatbots are computer programs that are capable of maintaining a conversation with a user in natural language, understanding their intent, and replying based upon preset rules and data, and may be designed to convincingly simulate the way a human would behave as a conversational partner.

Chatbots are used in dialog systems for various purposes including customer service, request routing, or information gathering. While some chatbot applications use extensive word-classification processes, natural-language processors, and sophisticated AI, others simply scan for general keywords and generate responses using common phrases obtained from an associated library or database.

Most chatbots are accessed on-line via website popups or through virtual assistants. They can be classified into usage categories that include: commerce (e-commerce via chat), education, entertainment, finance, health, news, and productivity.

For the purposes of this discussion, ChatGPT is an artificial intelligence chatbot. It is built on a family of large language models and has been fine-tuned (an approach to transfer learning) using both supervised and reinforcement learning techniques. ChatGPT is a member of the generative pre-trained transformer (GPT) family of language models. It was fine-tuned (an approach to transfer learning) over previous versions. The fine-tuning process leveraged both supervised learning as well as reinforcement learning in a process called reinforcement learning from human feedback (RLHF). Both approaches used human trainers to improve the model's performance. In the case of supervised learning, the model was provided with conversations in which the trainers played both sides: the user and the AI assistant. In the reinforcement learning step, human trainers first ranked responses that the model had created in a previous conversation. These rankings were used to create ‘reward models’ that the model was further fine-tuned on using several iterations of Proximal Policy Optimization (PPO). Proximal Policy Optimization algorithms present a cost-effective benefit to trust region policy optimization algorithms; they negate many of the computationally expensive operations with faster performance. In addition, chatbots similar to and including ChatGPT continue to gather data from users that could be used to further train and fine-tune the chatbot. Users can upvote or downvote responses they receive from ChatGPT and fill out a text field with additional feedback. The reward model of ChatGPT, designed around human oversight, can be over-optimized and thus hinder performance.

Although the core function of a chatbot is to mimic a human conversationalist, ChatGPT represents a type of chatbot that is versatile. For example, it can write and debug computer programs, compose music, teleplays, fairy tales, and student essays; answer test questions (sometimes, depending on the test, at a level above the average human test-taker); write poetry and song lyrics; emulate a Linux system; simulate an entire chat room; play games like tic-tac-toe; and simulate an ATM. ChatGPT training data includes many pages and information about internet phenomena and programming languages, such as bulletin board systems and the Python programming language.

### EXEMPLARY EMBODIMENTS

In one exemplary embodiment, a computing device for generating a transportation route using machine learning and/or artificial intelligence tools may be provided. The computing device may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, a computing device may comprise at least one memory and at least one processor in communication with the at least one memory. The at least one processor may be programmed to: (a) cause, using an application executing on the user device, the user device to display a plurality of trip assignments, each of the plurality of trip assignments associated with a trip assignment provider device of a plurality of trip assignment provider devices; (b) receive, from the user device, a selection of one or more of the plurality of trip assignments, each of the one or more selected trip assignments including trip information, the trip information including at least an origin and a destination; (c) generate a route based upon the trip information using an AI model, wherein the AI model is trained using historical trip records including historical trip information associated with historical trips; and (d) cause, using the application, the user device to display the generated route. The computing device may perform additional, less, or alternate functionality, including that discussed elsewhere herein.

In certain embodiments, the at least one processor may be further configured to retrieve driver information corresponding to the user and select the plurality of trip assignments to display based upon the driver information.

In some such embodiments, the driver information may indicates trip assignment provider devices with which the user has registered.

In some embodiments, the at least one processor may be further configured to receive the plurality of trip assignments from the plurality of trip assignment provider devices.

In certain embodiments, the at least one processor may be further configured to transmit an acceptance message to trip assignment provider devices of the plurality of trip assignment provider devices that are associated with the selected one or more of the plurality of trip assignments.

In some embodiments, the at least one processor may be further configured to train the AI model based upon the historical trip records.

In certain embodiments, the optimal route may include each origin and each destination associated with of the one or more selected trip assignments.

In some embodiments the at least one processor may be further configured to receive telematics data generated by the user device executing the application while the user is traveling the optimal route.

In certain such embodiments, the at least one processor may be further configured to determine a first trip assignment of the one or more selected trip assignments has been completed based upon the telematics data.

In some such embodiments, the at least one processor may be further configured to transmit a completion message indicating the first trip assignment has been completed to the trip assignment provider devices associated with the first trip assignment.

In certain such embodiments, the at least one processor may be further configured to compute a cost or score based upon the received telematics data and cause, using the application, the user device to display the computed cost or score.

In some such embodiments the at least one processor may be further configured to determine a current location of the user device based upon the telematics data and cause, using the application, the user device to display at least one instruction determined based upon the current location of the user device.

In another exemplary embodiment, a computer-implemented method for generating a transportation route using machine learning and/or AI tools may be provided. The computer-implemented method may be performed by one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. The computer-implemented method may include: (a) causing, using an application executing on the user device, the user device to display a plurality of trip assignments, each of the plurality of trip assignments associated with a trip assignment provider device of a plurality of trip assignment provider devices; (b) receiving, from the user device, a selection of one or more of the plurality of trip assignments, each of the one or more selected trip assignments including trip information, the trip information including at least an origin and a destination; (c) generating a route based upon the trip information using an AI model, wherein the AI model is trained using historical trip records including historical trip information associated with historical trips; and (d) causing, using the application, the user device to display the generated route. The computer-implemented method may include additional, less, or alternate functionality, including that discussed elsewhere herein.

In certain embodiments, the computer-implemented method may further include retrieving driver information corresponding to the user and selecting the plurality of trip assignments to display based upon the driver information.

In some such embodiments, the driver information may indicate trip assignment provider devices with which the user has registered.

In some embodiments, the computer-implemented method may further include receiving the plurality of trip assignments from the plurality of trip assignment provider devices.

In certain embodiments, the computer-implemented method may further include transmitting an acceptance message to trip assignment provider devices of the plurality of trip assignment provider devices that are associated with the selected one or more of the plurality of trip assignments.

In some embodiments, the computer-implemented method may further include training the AI model based upon the historical trip records.

In certain embodiments, the optimal route may include each origin and each destination associated with of the one or more selected trip assignments.

In some embodiments, the computer-implemented method may further include receiving telematics data generated by the user device executing the application while the user is traveling the optimal route.

In certain such embodiments, the computer-implemented method may further include determining a first trip assignment of the one or more selected trip assignments has been completed based upon the telematics data.

In some such embodiments, the computer-implemented method may further include transmitting a completion message indicating the first trip assignment has been completed to the trip assignment provider devices associated with the first trip assignment.

In certain such embodiments, the computer-implemented method may further include computing a cost or score based upon the received telematics data and causing, using the application, the user device to display the computed cost or score.

In some such embodiments, the computer-implemented method may further include determining a current location of the user device based upon the telematics data and causing, using the application, the user device to display at least one instruction determined based upon the current location of the user device.

In a further exemplary embodiment, a non-transitory computer-readable media for generating a transportation route using machine learning and/or AI tools may be provided. The non-transitory computer-readable storage media may include computer-executable instructions that may be executed by one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, a computer system may include at least one memory and at least one processor in communication with the at least one memory. The computer-executable instructions may cause the at least one processor to: (a) cause, using an application executing on the user device, the user device to display a plurality of trip assignments, each of the plurality of trip assignments associated with a trip assignment provider device of a plurality of trip assignment provider devices; (b) receive, from the user device, a selection of one or more of the plurality of trip assignments, each of the one or more selected trip assignments including trip information, the trip information including at least an origin and a destination; (c) generate a route based upon the trip information using an AI model, wherein the AI model is trained using historical trip records including historical trip information associated with historical trips; and (d) cause, using the application, the user device to display the generated route. The computer-executable instructions may direct additional, less, or alternate functionality, including that discussed elsewhere herein.

In certain embodiments, the computer-executable instructions may further cause the at least one processor to retrieve driver information corresponding to the user and select the plurality of trip assignments to display based upon the driver information.

In some such embodiments, the driver information may indicate trip assignment provider devices with which the user has registered.

In some embodiments, wherein computer-executable instructions may further cause the at least one processor to receive the plurality of trip assignments from the plurality of trip assignment provider devices.

In certain embodiments, the computer-executable instructions may further cause the at least one processor to transmit an acceptance message to trip assignment provider devices of the plurality of trip assignment provider devices that are associated with the selected one or more of the plurality of trip assignments.

In some embodiments, the computer-executable instructions may further cause the at least one processor to train the AI model based upon the historical trip records.

In certain embodiments, the optimal route may include each origin and each destination associated with of the one or more selected trip assignments.

In some embodiments, the computer-executable instructions may further cause the at least one processor to receive telematics data generated by the user device executing the application while the user is traveling the optimal route.

In certain such embodiments, the computer-executable instructions may further cause the at least one processor to determine a first trip assignment of the one or more selected trip assignments has been completed based upon the telematics data.

In some such embodiments, the computer-executable instructions may further cause the at least one processor to transmit a completion message indicating the first trip assignment has been completed to the trip assignment provider devices associated with the first trip assignment.

In certain such embodiments, wherein computer-executable instructions may further cause the at least one processor to compute a cost or score based upon the received telematics data and cause, using the application, the user device to display the computed cost or score.

In some such embodiments, the computer-executable instructions may further cause the at least one processor to determine a current location of the user device based upon the telematics data and cause, using the application, the user device to display at least one instruction determined based upon the current location of the user device.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an exemplary embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process may be practiced independent and separate from other components and processes described herein. Each component and process may also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A computing device comprising at least one processor in communication with at least one memory device and with a user device corresponding to a user, the at least one processor configured to:
cause, using an application executing on the user device, the user device to display a plurality of trip assignments, each of the plurality of trip assignments associated with a trip assignment provider device of a plurality of trip assignment provider devices;
receive, from the user device, a selection of one or more of the plurality of trip assignments, each of the one or more selected trip assignments including trip information, the trip information including at least an origin and a destination;
generate an optimal route based upon the trip information using an artificial intelligence (AI) model, wherein the AI model is trained using historical trip records including historical trip information associated with historical trips; and
cause, using the application, the user device to display the generated optimal route.

2. The computing device of claim 1, wherein the at least one processor is further configured to:
retrieve driver information corresponding to the user; and
select the plurality of trip assignments to display based upon the driver information.

3. The computing device of claim 2, wherein the driver information indicates trip assignment provider devices with which the user has registered.

4. The computing device of claim 1, wherein the at least one processor is further configured to receive the plurality of trip assignments from the plurality of trip assignment provider devices.

5. The computing device of claim 1, wherein the at least one processor is further configured to transmit an acceptance message to trip assignment provider devices of the plurality of trip assignment provider devices that are associated with the selected one or more of the plurality of trip assignments.

6. The computing device of claim 1, wherein the at least one processor is further configured to train the AI model based upon the historical trip records.

7. The computing device of claim 1, wherein the optimal route includes each origin and each destination associated with of the one or more selected trip assignments.

8. The computing device of claim 1, wherein the at least one processor is further configured to receive telematics data generated by the user device executing the application while the user is traveling the optimal route.

9. The computing device of claim 8, wherein the at least one processor is further configured to determine a first trip assignment of the one or more selected trip assignments has been completed based upon the telematics data.

10. The computing device of claim 9, wherein the at least one processor is further configured to transmit a completion message indicating the first trip assignment has been completed to the trip assignment provider devices associated with the first trip assignment.

11. The computing device of claim 8, wherein the at least one processor is further configured to:
compute a cost or score based upon the received telematics data; and
cause, using the application, the user device to display the computed cost or score.

12. The computing device of claim 8, wherein the at least one processor is further configured to:
determine a current location of the user device based upon the telematics data; and
cause, using the application, the user device to display at least one instruction determined based upon the current location of the user device.

13. A computer-implemented method for generating routes, the computer-implemented method performed by a computing device including at least one processor in communication with at least one memory device and with a user device corresponding to a user, the computer-implemented method including:
causing, using an application executing on the user device, the user device to display a plurality of trip assignments, each of the plurality of trip assignments associated with a trip assignment provider device of a plurality of trip assignment provider devices;
receiving, from the user device, a selection of one or more of the plurality of trip assignments, each of the one or more selected trip assignments including trip information, the trip information including at least an origin and a destination;
generating an optimal route based upon the trip information using an artificial intelligence (AI) model, wherein the AI model is trained using historical trip records including historical trip information associated with historical trips; and
causing, using the application, the user device to display the generated optimal route.

14. The computer-implemented method of claim 13, further comprising:
retrieving driver information corresponding to the user; and
selecting the plurality of trip assignments to display based upon the driver information.

15. The computer-implemented method of claim 14, wherein the driver information indicates trip assignment provider devices with which the user has registered.

16. The computer-implemented method of claim 13, further comprising receiving the plurality of trip assignments from the plurality of trip assignment provider devices.

17. The computer-implemented method of claim 13, further comprising transmitting an acceptance message to trip assignment provider devices of the plurality of trip assignment provider devices that are associated with the selected one or more of the plurality of trip assignments.

18. The computer-implemented method of claim 13, further comprising training the AI model based upon the historical trip records.

19. The computer-implemented method of claim 13, wherein the optimal route includes each origin and each destination associated with of the one or more selected trip assignments.

20. At least one non-transitory computer-readable media having computer-executable instructions embodied thereon, wherein when executed by a computing device including at least one processor in communication with at least one memory device and with a user device corresponding to a user, the computer-executable instruction cause the at least one processor to:
cause, using an application executing on the user device, the user device to display a plurality of trip assignments, each of the plurality of trip assignments associated with a trip assignment provider device of a plurality of trip assignment provider devices;
receive, from the user device, a selection of one or more of the plurality of trip assignments, each of the one or more selected trip assignments including trip information, the trip information including at least an origin and a destination;
generate an optimal route based upon the trip information using an artificial intelligence (AI) model, wherein the AI model is trained using historical trip records including historical trip information associated with historical trips; and
cause, using the application, the user device to display the generated optimal route.
